(19) United States
(12) Patent Application Publication
(10) Pub. No.: US 2009/0033612 A1
(43) Pub. Date: Feb. 5, 2009

(54) CORRECTION OF TEMPERATURE INDUCED COLOR DRIFT IN SOLID STATE LIGHTING DISPLAYS

(76) Inventors: John K. Roberts, Grand Rapids, MI (US); Keith J. Vadas, Lowell, MI (US)

Correspondence Address: MYERS BIGEL SIBLEY & SAJOVEC, P.A., P.O. BOX 37428, RALEIGH, NC, 27627, US

(21) Appl. No.: 11/831,287

(22) Filed: Jul. 31, 2007

(51) Int. Cl. G09G 3/36

(52) U.S. Cl. 345/102

(57) ABSTRACT

Methods of controlling a display including a backlight unit having a plurality of solid state light emitting devices are disclosed. The methods include receiving a target color point for the display, measuring a temperature associated with the display, generating a compensated target color point in response to the measured temperature, and setting a color point of the backlight unit to produce the compensated target color point.

### FIELD OF THE INVENTION

The present invention relates to solid state lighting, and more particularly to adjustable solid state lighting panels and to systems and methods for adjusting the light output of solid state lighting panels.

### BACKGROUND

Solid state lighting arrays are used for a number of lighting applications. For example, solid state lighting panels including arrays of solid state lighting devices have been used as direct illumination sources, such as in architectural and/or accent lighting. A solid state lighting device may include, for example, a packaged light emitting device including one or more light emitting diodes (LEDs). Inorganic LEDs typically include semiconductor layers forming p-n junctions. Organic LEDs (OLEDs), which include organic light emission layers, are another type of solid state light emitting device. Typically, a solid state light emitting device generates light through the recombination of electronic carriers, i.e. electrons and holes, in a light emitting layer or region.

Solid state lighting panels are commonly used as backlights for small liquid crystal display (LCD) display screens, such as LCD display screens used in portable electronic devices. In addition, there has been increased interest in the use of solid state lighting panels as backlights for larger displays, such as LCD television displays.

For smaller LCD screens, backlight assemblies typically employ white LED lighting devices that include a blue-emitting LED coated with a wavelength conversion phosphor that converts some of the blue light emitted by the LED into yellow light. The resulting light, which is a combination of blue light and yellow light, may appear white to an observer. However, while light generated by such an arrangement may appear white, objects illuminated by such light may not appear to have a natural coloring, because of the limited spectrum of the light. For example, because the light may have little energy in the red portion of the visible spectrum, red colors in an object may not be illuminated well by such light. As a result, the object may appear to have an unnatural coloring when viewed under such a light source.

The color rendering index of a light source is an objective measure of the ability of the light generated by the source to accurately illuminate a broad range of colors. The color rendering index ranges from essentially zero for monochromatic sources to nearly 100 for incandescent sources. Light generated from a phosphor-based solid state light source may have a relatively low color rendering index.

For large-scale backlight and illumination applications, it is often desirable to provide a lighting source that generates a white light having a high color rendering index, so that objects and/or display screens illuminated by the lighting panel may appear more natural. Accordingly, such lighting sources may typically include an array of solid state lighting devices including red, green and blue light emitting devices. When red, green and blue light emitting devices are energized simultaneously, the resulting combined light may appear white, or nearly white, depending on the relative intensities of the red, green and blue sources. There are many different hues of light that may be considered “white.” For example, some “white” light, such as light generated by sodium vapor lighting devices, may appear yellowish in color, while other “white” light, such as light generated by some fluorescent lighting devices, may appear more bluish in color.

The chromaticity of a particular light source may be referred to as the “color point” of the source. For a white light source, the chromaticity may be referred to as the “white point” of the source. The white point of a white light source may fall along a locus of chromaticity points corresponding to the color of light emitted by a black-body radiator heated to a given temperature. Accordingly, a white point may be identified by a correlated color temperature (CCT) of the light source, which is the temperature at which the heated black-body radiator matches the hue of the light source. White light typically has a CCT of between about 4000K and 8000K. White light with a CCT of 4000K has a yellowish color, while light with a CCT of 8000K is more bluish in color.

### SUMMARY

Some embodiments of the invention provide methods of controlling a display including a backlight unit having a plurality of solid state light emitting devices. The methods include receiving a target color point for the display, measuring a temperature associated with the display, generating a compensated target color point in response to the measured temperature, and setting a color point of the backlight unit to produce the compensated target color point. Setting the color point of the backlight unit may include changing a pulse width of a pulse width modulated current drive signal applied to at least one of the plurality of solid state lighting devices.

The target color point may include an x-coordinate and a y-coordinate in a two dimensional color space, and generating the compensated target color point may include transforming the x-coordinate of the target color point using a transformation equation. The transformation equation may include a linear transformation equation including a linear transformation coefficient.

In some embodiments, the transformation equation may include a first transformation equation, and generating the compensated target color point may include transforming the y-coordinate of the target color point using a second transformation equation.

The linear transformation coefficient may include a first linear transformation coefficient, and the second transformation equation may include a linear transformation equation including a second linear transformation coefficient.

The compensated target color point may be generated in response to a difference between the measured temperature and a calibration temperature.

In particular embodiments, the compensated target color point may be generated using the equations X′=X+mx*DeltaT and Y′=Y+my*DeltaT, where (X, Y) are coordinates of the target color point, (X′, Y′) are coordinates of the compensated target color point, mx and my are first and second linear transformation coeffiecients, respectively, and DeltaT represents the difference between the measured temperature and the calibration temperature.

Setting the color point of the backlight unit to the compensated target color point may include adjusting a pulse width modulation signal that is applied to at least one of the plurality of solid state lighting devices in the backlight unit.

Methods of calibrating a display including a solid state backlight unit according to some further embodiments of the invention include setting a temperature of the display to a first temperature level, generating light from the solid state backlight unit, and measuring a first color point of light output by the display at the first temperature level. The temperature is set to a second temperature level that is different from the first temperature level, light is generated from the solid state backlight unit, and a second color point of light output by the display is measured at the second temperature level. A transformation coefficient is generated in response to the first color point, the second color point, and the temperature difference between the first temperature and the second temperature. The transformation coefficient is then stored in the display for later use.

The transformation coefficient may be generated by performing a linear curve fitting to obtain a linear equation, and the transformation coefficient may be the slope of the linear equation.

The first color point may be measured using an external calorimeter.

A display according to some embodiments includes a solid state backlight unit and a feedback control system coupled to the solid state backlight unit. The feedback control system is configured to receive a target color point for the display, to measure a temperature associated with the display, to generate a compensated target color point in response to the measured temperature, and to set a color point of the backlight unit to produce the compensated target color point.

The control system may include a controller, a photosensor coupled to the controller and configured to measure a light output of the backlight unit, and a current driver coupled to the controller and configured to provide a pulse width modulated current drive signal to a solid state lighting element in the backlight unit in response to a command signal from the controller. The controller may be configured to control a pulse width modulation signal applied to at least one solid state light emitting device in the solid state backlight unit.

The target color point may include an x-coordinate and a y-coordinate in a two dimensional color space, and the control system may be configured to transform the x-coordinate of the target color point using a transformation equation to obtain the compensated color point.

The transformation equation may include a linear transformation equation including a linear transformation coefficient.

The control system may be configured to transform the y-coordinate of the target color point using a second transformation equation including a second linear transformation coefficient.

The control system may be configured to generate the compensated target color point in response to a difference between the measured temperature and a calibration temperature.

In particular embodiments, the control system may be configured to generate the compensated target color point using the equations X′=X+mx*DeltaT and Y′=Y+my*DeltaT, where (X, Y) are the coordinates of the target color point, (X′, Y′) are the coordinates of the compensated target color point, mx and my are first and second linear transformation coeffiecients, respectively, and DeltaT represents the difference between the measured temperature and the calibration temperature.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic illustration of a conventional LCD display;

FIG. 2 is a front view of a solid state lighting tile in accordance with some embodiments of the invention;

FIG. 3 is a schematic circuit diagram illustrating the electrical interconnection of LEDs in a solid state lighting tile in accordance with some embodiments of the invention;

FIG. 4A is a front view of a bar assembly including multiple solid state lighting tiles in accordance with some embodiments of the invention;

FIG. 4B is a front view of a lighting panel in accordance with some embodiments of the invention including multiple bar assemblies;

FIG. 5 is a schematic block diagram illustrating a lighting panel system in accordance with some embodiments of the invention;

FIGS. 6A-6D are a schematic diagrams illustrating possible configurations of photosensors on a lighting panel in accordance with some embodiments of the invention;

FIGS. 7 and 8 are schematic diagrams illustrating elements of a lighting panel system according to some embodiments of the invention;

FIG. 9 is a graph of a CIE color chart illustrating certain aspects of the invention;

FIGS. 10A and 10B are graphs of (x,y) color points of an LCD backlight unit and an LCD display, respectively.

FIGS. 11 and 12 are flowcharts illustrating systems and/or methods according to some embodiments of the invention.

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to flowchart illustrations and/or block diagrams of methods, systems and computer program products according to embodiments of the invention. It will be understood that some blocks of the flowchart illustrations and/or block diagrams, and combinations of some blocks in the flowchart illustrations and/or block diagrams, can be implemented by computer program instructions. These computer program instructions may be stored or implemented in a microcontroller, microprocessor, digital signal processor (DSP), field programmable gate array (FPGA), a state machine, programmable logic controller (PLC) or other processing circuit, general purpose computer, special purpose computer, or other programmable data processing apparatus such as to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

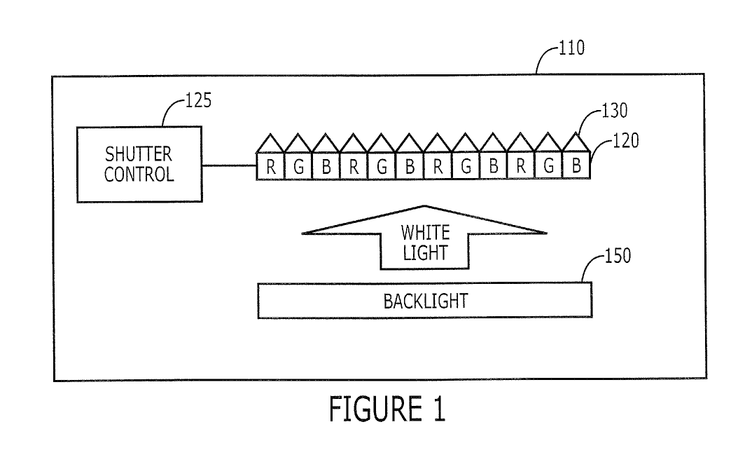

A schematic diagram of an LCD display 110 including a solid state backlight unit 200 is shown in FIG. 1. As shown therein, white light generated by a solid state backlight unit 200 is transmitted through a matrix of red (R), green (G) and blue (B) color filters 120. Transmission of light through a particular color filter 120 is controlled by an individually addressable liquid crystal shutter 130 associated with the color filter 120. The operation of the liquid crystal shutters 130 is controlled by a shutter controller 125 in response to video data provided, for example, by a host computer, a television tuner, or other video source.

Many components of an LCD display have optical properties that are temperature-dependent. For example, optical properties of the liquid crystal shutters 130 and/or the color filters 120, such as transmissivity and/or frequency response, may shift with temperature. Also, the response properties of a photosensor in the backlight control system may shift with temperature. To compound the problem, shifts in the optical properties of elements of the display 110 that are outside the backlight unit 200 may not be detectable by a photosensor located within the backlight unit 200. For example, a photosensor located within the backlight unit 150 may be unable to detect color point shifts in the output of the display 110 that occur due to changes in the optical properties of the liquid crystal shutters 130 and/or the color filters 120. The larger the difference in the actual system temperature as compared to the calibration temperature, the larger the color point error may become.

In production, the color point of the display may be calibrated when the display 110 is in a warmed-up state (e.g. about 70° C.). However, because of the large thermal mass of a full sized display, it may take a relatively long period of time for an LCD display 110 to reach the fully warmed-up state after being switched on. During the warm-up period, the actual color point of the display may be different from the color point measured by a photosensor in the backlight control system. That is, although the backlight unit 200 may be calibrated and controlled to produce light having a particular color point, the actual color point of the light output by the display 110 may be shifted from the desired color point. The largest color point error may occur at initial power-up, and may decline progressively until the system is fully warmed up, which may take 1-2 hours.

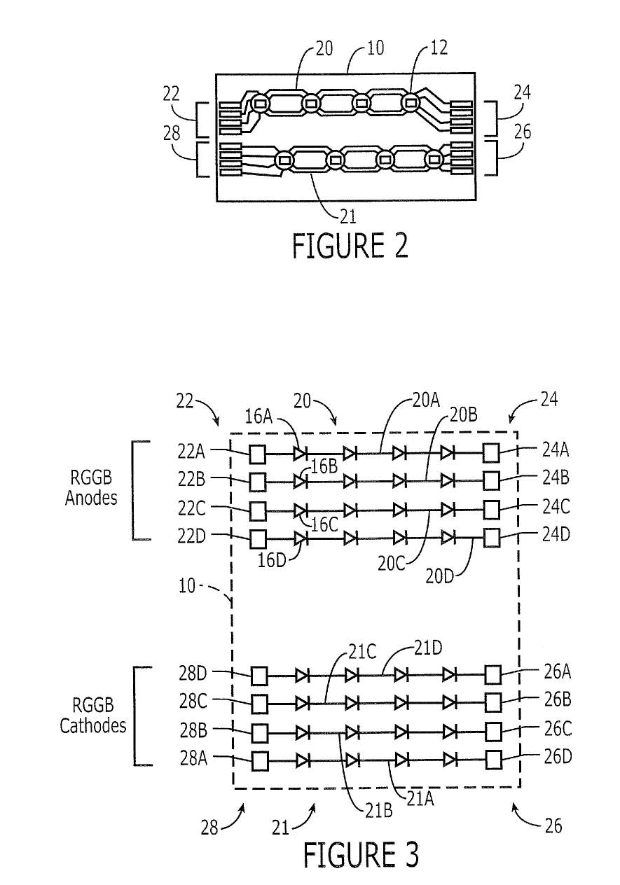

A solid state backlight unit for an LCD display may include a plurality of solid state lighting elements. The solid state lighting elements may be arranged on one or more solid state lighting tiles that can be arranged to form a two-dimensional lighting panel. Referring now to FIG. 2, a solid state lighting tile 10 may include thereon a number of solid state lighting elements 12 arranged in a regular and/or irregular two dimensional array. The tile 10 may include, for example, a printed circuit board (PCB) on which one or more circuit elements may be mounted. In particular, a tile 10 may include a metal core PCB (MCPCB) including a metal core having thereon a polymer coating on which patterned metal traces (not shown) may be formed. MCPCB material, and material similar thereto, is commercially available from, for example, The Bergquist Company. The PCB may further include heavy clad (4 oz. copper or more) and/or conventional FR-4 PCB material with thermal vias. MCPCB material may provide improved thermal performance compared to conventional PCB material. However, MCPCB material may also be heavier than conventional PCB material, which may not include a metal core.

In the embodiments illustrated in FIG. 2, the lighting elements 12 are multi-chip clusters of four solid state emitting devices per cluster. In the tile 10, four lighting elements 12 are serially arranged in a first path 20, while four lighting elements 12 are serially arranged in a second path 21. The lighting elements 12 of the first path 20 are connected, for example via printed circuits, to a set of four anode contacts 22 arranged at a first end of the tile 10, and a set of four cathode contacts 24 arranged at a second end of the tile 10. The lighting elements 12 of the second path 21 are connected to a set of four anode contacts 26 arranged at the second end of the tile 10, and a set of four cathode contacts 28 arranged at the first end of the tile 10.

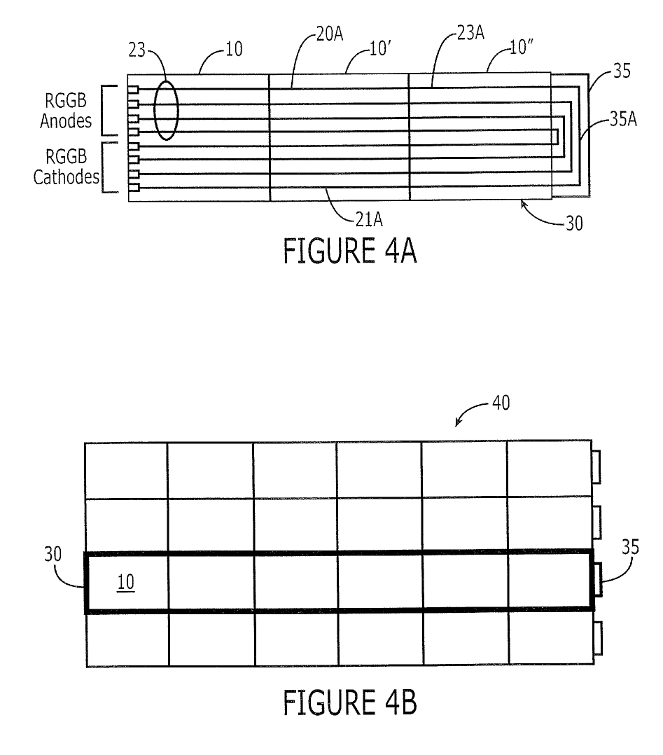

Referring to FIGS. 2 and 3, the solid state lighting elements 12 may include, for example, organic and/or inorganic light emitting devices. A solid state lighting element 12 may include a packaged discrete electronic component including a carrier substrate on which a plurality of LED chips 16A-16D are mounted. In other embodiments, one or more solid state lighting elements 12 may include LED chips 16A-16D mounted directly onto electrical traces on the surface of the tile 10, forming a multi-chip module or chip-on-board assembly. Suitable tiles are disclosed in commonly assigned U.S. patent application Ser. No. 11/601,500 entitled “SOLID STATE BACKLIGHTING UNIT ASSEMBLY AND METHODS” filed Nov. 17, 2006, the disclosure of which is incorporated herein by reference.

The LED chips 16A-16D may include at least a red LED 16A, a green LED 16B and a blue LED 16C. The blue and/or green LEDs may be InGaN-based blue and/or green LED chips available from Cree, Inc., the assignee of the present invention. The red LEDs may be, for example, AlInGaP LED chips available from Epistar Corporation, Osram Opto Semiconductors GmbH, and others. The lighting device 12 may include an additional green LED 16D in order to make more green light available.

In some embodiments, the LEDs 16A-16D may have a square or rectangular periphery with an edge length of about 900 μm or greater (i.e. so-called “power chips.” However, in other embodiments, the LED chips 16A-16D may have an edge length of 500 μm or less (i.e. so-called “small chips”). In particular, small LED chips may operate with better electrical conversion efficiency than power chips. For example, green LED chips with a maximum edge dimension less than 500 μm and as small as 260 μm, commonly have a higher electrical conversion efficiency than 900 μm chips, and are known to typically produce 55 lumens of luminous flux per Watt of dissipated electrical power and as much as 90 lumens of luminous flux per Watt of dissipated electrical power.

The LEDs 16A-16D may be covered by an encapsulant, which may be clear and/or may include light scattering particles, phosphors, and/or other elements to achieve a desired emission pattern, color and/or intensity. A lighting device 12 may further include a reflector cup surrounding the LEDs 16A-16D, a lens mounted above the LEDs 16A-16D, one or more heat sinks for removing heat from the lighting device, an electrostatic discharge protection chip, and/or other elements.

LED chips 16A-16D of the lighting elements 12 in the tile 10 may be electrically interconnected as shown in the schematic circuit diagram in FIG. 3. As shown therein, the LEDs may be interconnected such that the blue LEDs 16A in the first path 20 are connected in series to form a string 20A. Likewise, the first green LEDs 16B in the first path 20 may be arranged in series to form a string 20B, while the second green LEDs 16D may be arranged in series to form a separate string 20D. The red LEDs 16C may be arranged in series to form a string 20C. Each string 20A-20D may be connected to an anode contact 22A-22D arranged at a first end of the tile 10 and a cathode contact 24A-24D arranged at the second end of the tile 10, respectively.

A string 20A-20D may include all, or less than all, of the corresponding LEDs in the first path 20 or the second path 21. For example, the string 20A may include all of the blue LEDs from all of the lighting elements 12 in the first path 20. Alternatively, a string 20A may include only a subset of the corresponding LEDs in the first path 20. Accordingly the first path 20 may include four serial strings 20A-20D arranged in parallel on the tile 10.

The second path 21 on the tile 10 may include four serial strings 21A, 21B, 21C, 21D arranged in parallel. The strings 21A to 21D are connected to anode contacts 26A to 26D, which are arranged at the second end of the tile 10 and to cathode contacts 28A to 28D, which are arranged at the first end of the tile 10, respectively.

It will be appreciated that, while the embodiments illustrated in FIGS. 2-3 include four LED chips 16 per lighting device 12 which are electrically connected to form at least four strings of LEDs 16 per path 20, 21, more and/or fewer than four LED chips 16 may be provided per lighting device 12, and more and/or fewer than four LED strings may be provided per path 20, 21 on the tile 10. For example, a lighting device 12 may include only one green LED chip 16B, in which case the LEDs may be connected to form three strings per path 20, 21. Likewise, in some embodiments, the two green LED chips in a lighting device 12 may be connected in series to one another, in which case there may only be a single string of green LED chips per path 20, 22. Further, a tile 10 may include only a single path 20 instead of plural paths 20, 21 and/or more than two paths 20, 21 may be provided on a single tile 10.

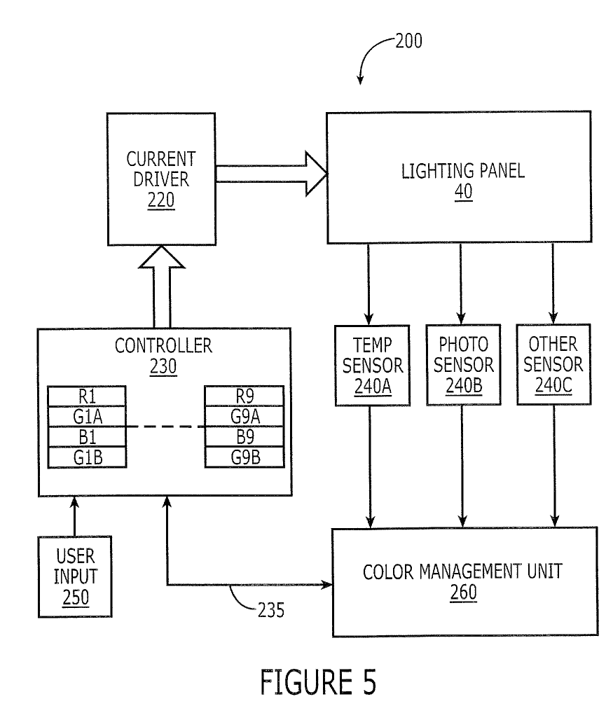

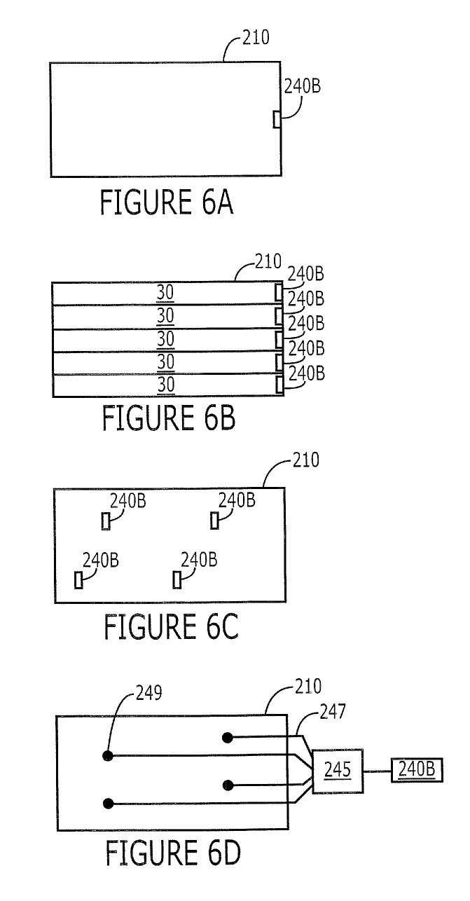

Multiple tiles 10 may be assembled to form a larger lighting bar assembly 30 as illustrated in FIG. 4A. As shown therein, a bar assembly 30 may include two or more tiles 10, 10′, 10″ connected end-to-end. Accordingly, referring to FIGS. 3 and 4A, the cathode contacts 24 of the first path 20 of the leftmost tile 10 may be electrically connected to the anode contacts 22 of the first path 20 of the central tile 10′, and the cathode contacts 24 of the first path 20 of the central tile 10′ may be electrically connected to the anode contacts 22 of the first path 20 of the rightmost tile 10″, respectively. Similarly, the anode contacts 26 of the second path 21 of the leftmost tile 10 may be electrically connected to the cathode contacts 28 of the second path 21 of the central tile 10′, and the anode contacts 26 of the second path 21 of the central tile 10′ may be electrically connected to the cathode contacts 28 of the second path 21 of the rightmost tile 10″, respectively.

Furthermore, the cathode contacts 24 of the first path 20 of the rightmost tile 10″ may be electrically connected to the anode contacts 26 of the second path 21 of the rightmost tile 10″ by a loopback connector 35. For example, the loopback connector 35 may electrically connect the cathode 24A of the string 20A of blue LED chips 16A of the first path 20 of the rightmost tile 10″ with the anode 26A of the string 21A of blue LED chips of the second path 21 of the rightmost tile 100″. In this manner, the string 20A of the first path 20 may be connected in series with the string 21A of the second path 21 by a conductor 35A of the loopback connector 35 to form a single string 23A of blue LED chips 16. The other strings of the paths 20, 21 of the tiles 10, 10′, 10″ may be connected in a similar manner.

The loopback connector 35 may include an edge connector, a flexible wiring board, or any other suitable connector. In addition, the loop connector may include printed traces formed on/in the tile 10.

While the bar assembly 30 shown in FIG. 4A is a one dimensional array of tiles 10, other configurations are possible. For example, the tiles 10 could be connected in a two-dimensional array in which the tiles 10 are all located in the same plane, or in a three dimensional configuration in which the tiles 10 are not all arranged in the same plane. Furthermore the tiles 10 need not be rectangular or square, but could, for example, be hexagonal, triangular, or the like.

Referring to FIG. 4B, in some embodiments, a plurality of bar assemblies 30 may be combined to form a lighting panel 40, which may be used, for example, as a backlighting unit (BLU) for an LCD display. As shown in FIG. 4B, a lighting panel 40 may include four bar assemblies 30, each of which includes six tiles 10. The rightmost tile 10 of each bar assembly 30 includes a loopback connector 35. Accordingly, each bar assembly 30 may include four strings 23 of LEDs (i.e. one red, two green and one blue).

In some embodiments, a bar assembly 30 may include four LED strings 23 (one red, two green and one blue). Thus, a lighting panel 40 including nine bar assemblies may have 36 separate strings of LEDs. Moreover, in a bar assembly 30 including six tiles 10 with eight solid state lighting elements 12 each, an LED string 23 may include 48 LEDs connected in serial.

For some types of LEDs, in particular blue and/or green LEDs, the forward voltage (Vf) may vary by as much as +/−0.75V from a nominal value from chip to chip at a standard drive current of 20 mA. A typical blue or green LED may have a Vf of 3.2 Volts. Thus, the forward voltage of such chips may vary by as much as 25%. For a string of LEDs containing 48 LEDs, the total Vf required to operate the string at 20 mA may vary by as much as +/−36V.

Accordingly, depending on the particular characteristics of the LEDs in a bar assembly, a string of one light bar assembly (e.g., the blue string) may require significantly different operating power compared to a corresponding string of another bar assembly. These variations may significantly affect the color and/or brightness uniformity of a lighting panel that includes multiple tiles 10 and/or bar assemblies 30, as such Vf variations may lead to variations in brightness and/or hue from tile to tile and/or from bar to bar. For example, current differences from string to string may result in large differences in the flux, peak wavelength, and/or dominant wavelength output by a string. Variations in LED drive current on the order of 5% or more may result in unacceptable variations in light output from string to string and/or from tile to tile. Such variations may significantly affect the overall color gamut, or range of displayable colors, of a lighting panel.

In addition, the light output characteristics of LED chips may change during their operational lifetime. For example, the light output by an LED may change over time and/or with ambient temperature.

In order to provide consistent, controllable light output characteristics for a lighting panel, some embodiments of the invention provide a lighting panel having two or more serial strings of LED chips. An independent current control circuit is provided for each of the strings of LED chips. Furthermore, current to each of the strings may be individually controlled, for example, by means of pulse width modulation (PWM) and/or pulse frequency modulation (PFM). The width of pulses applied to a particular string in a PWM scheme (or the frequency of pulses in a PFM scheme) may be based on a pre-stored pulse width (frequency) value that may be modified during operation based, for example, on a user input and/or a sensor input.

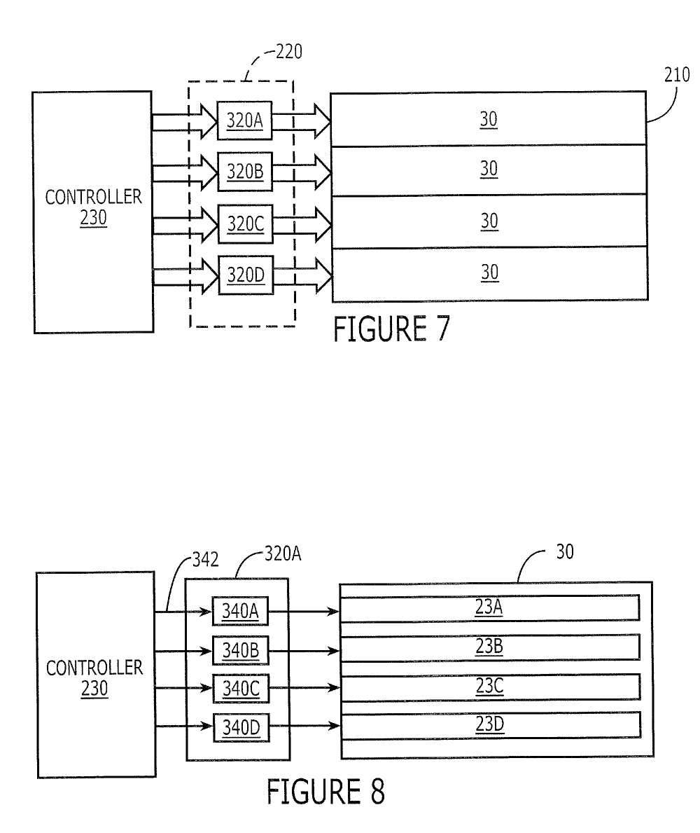

Accordingly, referring to FIG. 5, a lighting panel system 200 is shown. The lighting panel system 200, which may be a backlight for an LCD display, includes a lighting panel 40. The lighting panel 40 may include, for example, a plurality of bar assemblies 30, which, as described above, may include a plurality of tiles 10. However, it will be appreciated that embodiments of the invention may be employed in conjunction with lighting panels formed in other configurations. For example, some embodiments of the invention may be employed with solid state backlight panels that include a single, large area tile.

In particular embodiments, however, a lighting panel 40 may include a plurality of bar assemblies 30, each of which may have four cathode connectors and four anode connectors corresponding to the anodes and cathodes of four independent strings 23 of LEDs each having the same dominant wavelength. For example, each bar assembly 30 may have a red string, two green strings, and a blue string, each with a corresponding pair of anode/cathode contacts on one side of the bar assembly 30. In particular embodiments, a lighting panel 40 may include nine bar assemblies 30. Thus, a lighting panel 40 may include 36 separate LED strings.

A current driver 220 provides independent current control for each of the LED strings 23 of the lighting panel 40. For example, the current driver 220 may provide independent current control for 36 separate LED strings in the lighting panel 40. The current driver 220 may provide a constant current source for each of the 36 separate LED strings of the lighting panel 40 under the control of a controller 230. In some embodiments, the controller 230 may be implemented using an 8-bit microcontroller such as a PIC18F8722 from Microchip Technology Inc., which may be programmed to provide pulse width modulation (PWM) control of 36 separate current supply blocks within the driver 220 for the 36 LED strings 23.

Pulse width information for each of the 36 LED strings 23 may be obtained by the controller 230 from a color management unit 260, which may in some embodiments include a color management controller such as the Agilent HDJD-J822-SCR00 color management controller.

The color management unit 260 may be connected to the controller 230 through an I2C (Inter-integrated Circuit) communication link 235. The color management unit 260 may be configured as a slave device on an I2C communication link 235, while the controller 230 may be configured as a master device on the link 235. I2C communication links provide a low-speed signaling protocol for communication between integrated circuit devices. The controller 230, the color management unit 260 and the communication link 235 may together form a feedback control system configured to control the light output from the lighting panel 40. The registers R1-R9, etc., may correspond to internal registers in the controller 230 and/or may correspond to memory locations in a memory device (not shown) accessible by the controller 230.

The controller 230 may include a register, e.g. registers R1-R9, G1A-G9A, B1-B9, G1B-G9B, for each LED string 23, i.e. for a lighting unit with 36 LED strings 23, the color management unit 260 may include at least 36 registers. Each of the registers is configured to store pulse width information for one of the LED strings 23. The initial values in the registers may be determined by an initialization/calibration process. However, the register values may be adaptively changed over time based on user input 250 and/or input from one or more sensors 240A-C coupled to the lighting panel 40.

The sensors 240A-C may include, for example, a temperature sensor 240A, one or more photosensors 240B, and/or one or more other sensors 240C. In particular embodiments, a lighting panel 40 may include one photosensor 240B for each bar assembly 30 in the lighting panel. However, in other embodiments, one photosensor 240B could be provided for each LED string 30 in the lighting panel. In other embodiments, each tile 10 in the lighting panel 40 may include one or more photosensors 240B.

In some embodiments, the photosensor 240B may include photo-sensitive regions that are configured to be preferentially responsive to light having different dominant wavelengths. Thus, wavelengths of light generated by different LED strings 23, for example a red LED string 23A and a blue LED string 23C, may generate separate outputs from the photosensor 240B. In some embodiments, the photosensor 240B may be configured to independently sense light having dominant wavelengths in the red, green and blue portions of the visible spectrum. The photosensor 240B may include one or more photosensitive devices, such as photodiodes. The photosensor 240B may include, for example, an Agilent HDJD-S831-QT333 tricolor photo sensor.

Sensor outputs from the photosensors 240B may be provided to the color management unit 260, which may be configured to sample such outputs and to provide the sampled values to the controller 230 to adjust the register values for corresponding LED strings 23 to correct variations in light output on a string-by-string basis. In some embodiments, an application specific integrated circuit (ASIC) may be provided on each tile 10 along with one or more photosensors 240B in order to pre-process sensor data before it is provided to the color management unit 260. Furthermore, in some embodiments, the sensor output and/or ASIC output may be sampled directly by the controller 230.

The photosensors 240B may be arranged at various locations within the lighting panel 40 in order to obtain representative sample data. Alternatively and/or additionally, light guides such as optical fibers may be provided in the lighting panel 40 to collect light from desired locations. In that case, the photosensors 240B need not be arranged within an optical display region of the lighting panel 40, but could be provided, for example, on the back side of the lighting panel 40. Further, an optical switch may be provided to switch light from different light guides which collect light from different areas of the lighting panel 40 to a photosensor 240B. Thus, a single photosensor 240B may be used to sequentially collect light from various locations on the lighting panel 40.

The user input 250 may be configured to permit a user to selectively adjust attributes of the lighting panel 40, such as color temperature, brightness, hue, etc., by means of user controls such as input controls on an LCD panel.

The temperature sensor 240A may provide temperature information to the color management unit 260 and/or the controller 230, which may adjust the light output from the lighting panel on a string-to-string and/or color-to-color basis based on known/predicted brightness vs. temperature operating characteristics of the LED chips 16 in the strings 23.

Accordingly, the sensors 240A-C, the controller 230, the color management unit 260 and the current driver 220 form a feedback control system for controlling the lighting panel 40. Although the color management unit 260 is illustrated as a separate element, it will be appreciated that the functionality of the color management unit 260 may in some embodiments be performed by another element of the control system, such as the controller 230.

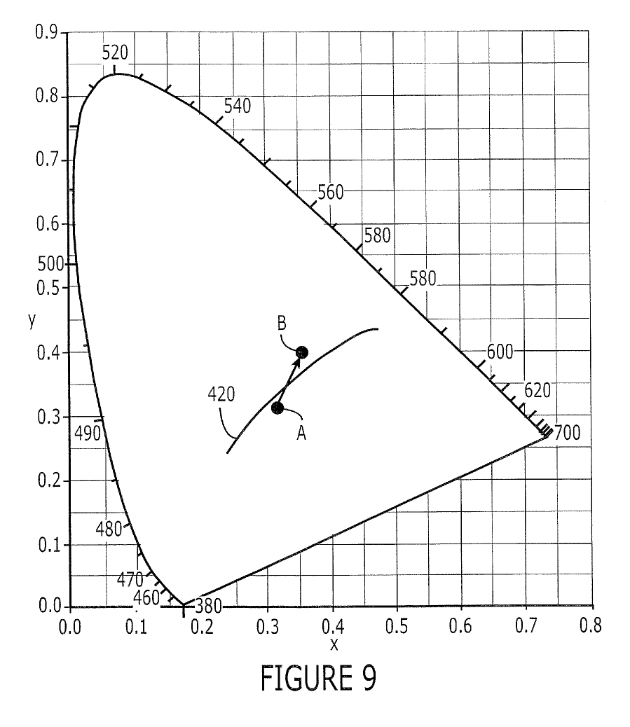

Various configurations of photosensors 240B are shown in FIGS. 6A-6D. For example, in the embodiments of FIG. 6A, a single photosensor 240B is provided in the lighting panel 40. The photosensor 240B may be provided at a location where it may receive an average amount of light from more than one tile/string in the lighting panel.

In order to provide more extensive data regarding light output characteristics of the lighting panel 40, more than one photosensor 240B may be used. For example, as shown in FIG. 6B, there may be one photosensor 240B per bar assembly 30. In that case, the photosensors 240B may be located at ends of the bar assemblies 30 and may be arranged to receive an average/combined amount of light emitted from the bar assembly 30 with which they are associated.

As shown in FIG. 6C, photosensors 240B may be arranged at one or more locations within a periphery of the light emitting region of the lighting panel 40. However in some embodiments, the photosensors 240B may be located away from the light emitting region of the lighting panel 40, and light from various locations within the light emitting region of the lighting panel 40 may be transmitted to the sensors 240B through one or more light guides. For example, as shown in FIG. 6D, light from one or more locations 249 within the light emitting region of the lighting panel 40 is transmitted away from the light emitting region via light guides 247, which may be optical fibers that may extend through and/or across the tiles 10. In the embodiments illustrated in FIG. 6D, the light guides 247 terminate at an optical switch 245, which selects a particular guide 247 to connect to the photosensor 240B based on control signals from the controller 230 and/or from the color management unit 260. It will be appreciated, however, that the optical switch 245 is optional, and that each of the light guides 245 may terminate at a photosensor 240B. In further embodiments, instead of an optical switch 245, the light guides 247 may terminate at a light combiner, which combines the light received over the light guides 247 and provides the combined light to a photosensor 240B. The light guides 247 may extend across partially across and/or through the tiles 10. For example, in some embodiments, the light guides 247 may run behind the panel 40 to various light collection locations and then run through the panel at such locations. Furthermore, the photosensor 240B may be mounted on a front side of the panel (i.e. on the side of the panel 40 on which the lighting devices 16 are mounted) or on a reverse side of the panel 40 and/or a tile 10 and/or bar assembly 30.

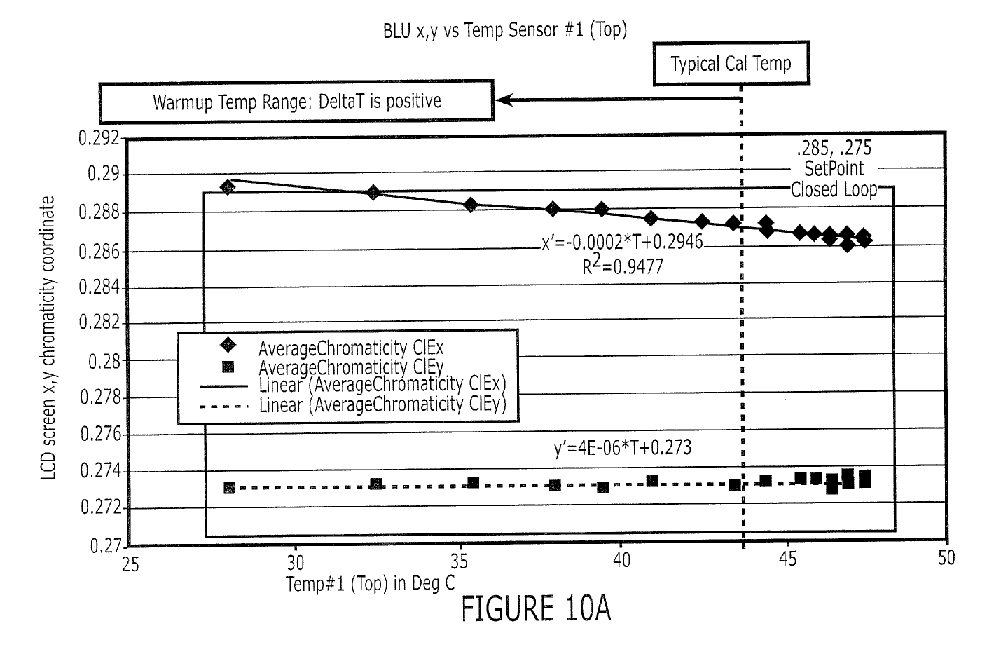

Referring now to FIG. 7, the current driver 220 may include a plurality of bar driver circuits 320A-320D. One bar driver circuit 320A-320D may be provided for each bar assembly 30 in a lighting panel 40. In the embodiments shown in FIG. 7, the lighting panel 40 includes four bar assemblies 30. However, in some embodiments the lighting panel 40 may include nine bar assemblies 30, in which case the current driver 220 may include nine bar driver circuits 320. As shown in FIG. 8, in some embodiments, each bar driver circuit 320 may include four current supply circuits 340A-340D, e.g., one current supply circuit 340A-340D for each LED string 23A-23D of the corresponding bar assembly 30. Operation of the current supply circuits 340A-340B may be controlled by control signals 342 from the controller 230.

The current supply circuits 340A-340B are configured to supply current to the corresponding LED strings 13 while a pulse width modulation signal PWM for the respective strings 13 is a logic HIGH. Accordingly, for each timing loop, the PWM input of each current supply circuit 340 in the driver 220 is set to logic HIGH at the first clock cycle of the timing loop. The PWM input of a particular current supply circuit 340 is set to logic LOW, thereby turning off current to the corresponding LED string 23, when a counter in the controller 230 reaches the value stored in a register of the controller 230 corresponding to the LED string 23. Thus, while each LED string 23 in the lighting panel 40 may be turned on simultaneously, the strings may be turned off at different times during a given timing loop, which would give the LED strings different pulse widths within the timing loop. The apparent brightness of an LED string 23 may be approximately proportional to the duty cycle of the LED string 23, i.e., the fraction of the timing loop in which the LED string 23 is being supplied with current.

An LED string 23 may be supplied with a substantially constant current during the period in which it is turned on. By manipulating the pulse width of the current signal, the average current passing through the LED string 23 may be altered even while maintaining the on-state current at a substantially constant value. Thus, the dominant wavelength of the LEDs 16 in the LED string 23, which may vary with applied current, may remain substantially stable even though the average current passing through the LEDs 16 is being altered. Similarly, the luminous flux per unit power dissipated by the LED string 23 may remain more constant at various average current levels than, for example, if the average current of the LED string 23 were being manipulated using a variable current source.

The value stored in a register of the controller 230 corresponding to a particular LED string may be based on a value received from the color management unit 260 over the communication link 235. Alternatively and/or additionally, the register value may be based on a value and/or voltage level directly sampled by the controller 230 from a sensor 240.

In some embodiments, the color management unit 260 may provide a value corresponding to a duty cycle (i.e. a value from 0 to 100), which may be translated by the controller 230 into a register value based on the number of cycles in a timing loop. For example, the color management unit 260 indicates to the controller 230 via the communication link 235 that a particular LED string 23 should have a duty cycle of 50%. If a timing loop includes 10,000 clock cycles, then assuming the controller increments the counter with each clock cycle, the controller 230 may store a value of 5000 in the register corresponding to the LED string in question. Thus, in a particular timing loop, the counter is reset to zero at the beginning of the loop and the LED string 23 is turned on by sending an appropriate PWM signal to the current supply circuit 340 serving the LED string 23. When the counter has counted to a value of 5000, the PWM signal for the current supply circuit 340 is reset, thereby turning the LED string off.

In some embodiments, the pulse repetition frequency (i.e. pulse repetition rate) of the PWM signal may be in excess of 60 Hz. In particular embodiments, the PWM period may be 5 ms or less, for an overall PWM pulse repetition frequency of 200 Hz or greater. A delay may be included in the loop, such that the counter may be incremented only 100 times in a single timing loop. Thus, the register value for a given LED string 23 may correspond directly to the duty cycle for the LED string 23. However, any suitable counting process may be used provided that the brightness of the LED string 23 is appropriately controlled.

The register values of the controller 230 may be updated from time to time to take into account changing sensor values. In some embodiments, updated register values may be obtained from the color management unit 260 multiple times per second.

Furthermore, the data read from the color management unit 260 by the controller 230 may be filtered to limit the amount of change that occurs in a given cycle. For example, when a changed value is read from the color management unit 260, an error value may be calculated and scaled to provide proportional control (“P”), as in a conventional PID (Proportional-Integral-Derivative) feedback controller. Further, the error signal may be scaled in an integral and/or derivative manner as in a PID feedback loop. Filtering and/or scaling of the changed values may be performed in the color management unit 260 and/or in the controller 230.

In some embodiments, calibration of a display system 200 may be performed by the display system itself (i.e. self-calibration), for example, using signals from photosensors 240B. However, in some embodiments of the invention, calibration of a display system 200 may be performed by an external calibration system.

As noted above, the user input 250 may permit a user to selectively adjust display attributes such as color temperature, brightness, hue, etc., by means of user controls such as input controls on an LCD panel. In particular, the user input 250 may permit the user to specify a color point, or white point, for the display 110.

However, many components of an LCD display have optical properties that are temperature dependent. For example, the optical properties of the liquid crystal shutters and/or the color filters of an LCD display may shift with temperature. Also, the response properties of a photosensor 240B in the backlight control system may shift with temperature. Furthermore, shifts in the optical properties of elements of the LCD display that are outside the backlight unit 200 may not be detectable by a photosensor 240B located within the backlight unit 200. For example, the photosensor 240B may be unable to detect color point shifts occurring due to changes in the optical properties of the liquid crystal shutters and/or the color filters of the display.

Some embodiments of the invention provide techniques for compensating for temperature-induced chromaticity errors using the feedback control system of the backlight unit 200.

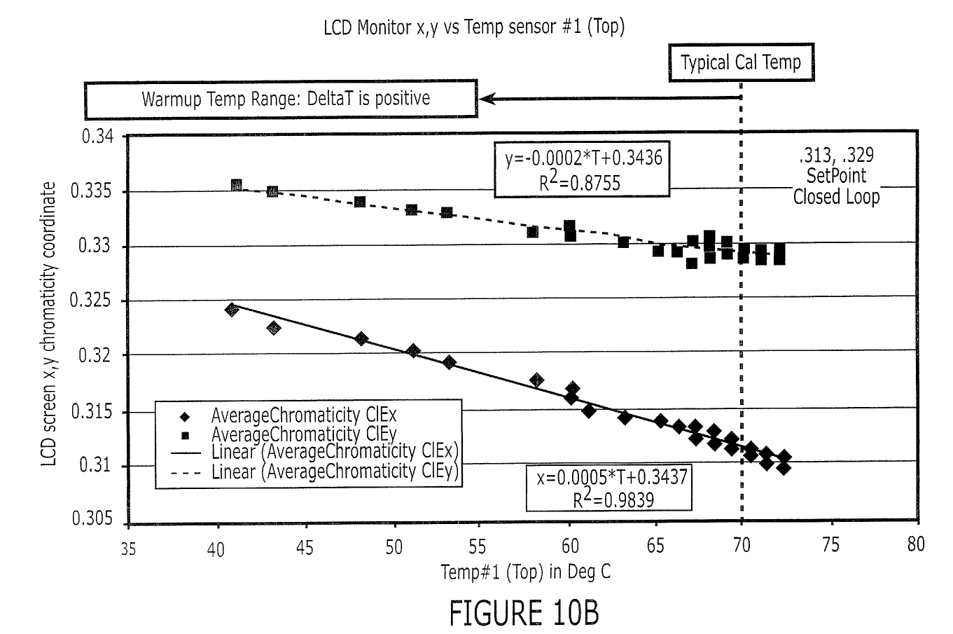

The color point of a backlight unit 200 can be plotted in a two-dimensional color space. For example, FIG. 9 is an approximate representation of a 1931 CIE chromaticity diagram. The 1931 CIE chromaticity diagram is a two-dimensional color space in which all visible colors are uniquely represented by a set of (x,y) coordinates. Other two-dimensional color spaces are known in the art, and may be used in some embodiments of the invention.

Referring to FIG. 9, fully saturated (i.e. pure) colors fall on the outside edge of the 1931 CIE chromaticity diagram, as indicated by the wavelength numbers running from 380 nm to 700 nm on the chart. Fully unsaturated light, which appears white, is found near the center of the chart. A blackbody radiation curve 420 (shown as a partial approximation in FIG. 9) plots the color point of light emitted by a blackbody radiator at various temperatures. The blackbody radiation curve 420 runs through the “white” region of the CIE diagram. Accordingly, some “white” points may be associated with particular color temperatures.

The feedback control system of the backlight unit 200 (for example, including the photosensor 240B, color management unit 260, controller 230 and current driver 220 illustrated in FIG. 5) may attempt to set the color point of the backlight unit 200 so that the display 110 will have a desired color point A when the display is at a first temperature T1 that is less than the calibration temperature. However, since the optical properties of the display are different at lower temperatures, the actual color point of the display may be shifted, for example to point B. (It will be appreciated that points A and B in FIG. 9 are provided for illustrative purposes only and may not represent an actual color point shift due to a temperature difference. Accordingly, the relative locations of points A and B, and the distance between points A and B in FIG. 9, are exaggerated for illustrative purposes.) Since the shift may be caused by elements of the LCD display 110 that cannot be detected by the photosensor 240B in the backlight unit 200, the actual color point of the display may be temporarily different than expected/requested by the user.

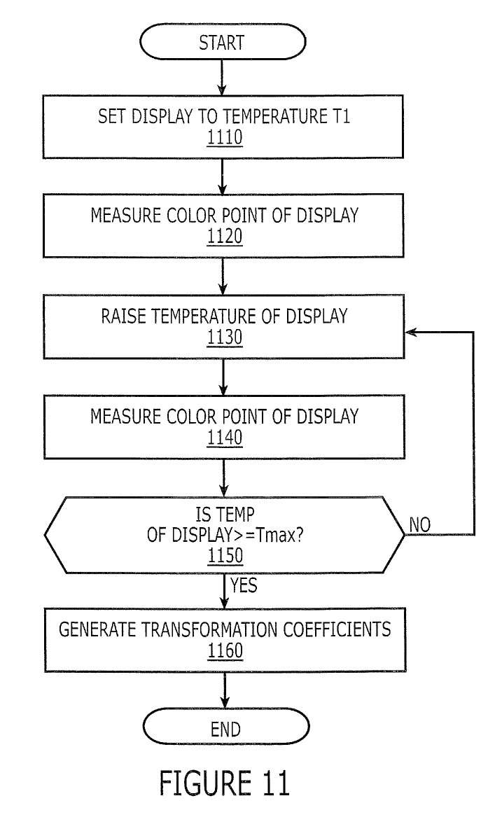

Color point errors of LCD displays, such as the LCD display 110, and of solid state backlight units, such as the solid state backlight unit 200, have been investigated by measuring the color points of a backlight unit 200 alone and of a full LCD display 110 at various temperatures. The results of the investigation are shown in FIGS. 10A and 10B. FIG. 10A shows the variation in X and Y chromaticity coordinates of the color point of a backlight unit alone. The X coordinate shows a moderate linear temperature dependence having a slope of about −0.0002° C.⁻¹. The Y coordinate shows negligible temperature dependence.

The temperature dependence of an LCD display 110 is more pronounced, since it may include additional elements, such as the liquid crystal shutters and/or color filters, that have temperature-dependent optical properties. For example, as shown in FIG. 10B, the X coordinate shows a strong linear temperature dependence having a slope of about −0.0005° C.⁻¹, while the Y coordinate shows a temperature dependence having a slope of about −0.0002° C.⁻¹.

To correct for this temperature dependence, a linear transformation may be applied to the desired color point to obtain a compensated color point, according to some embodiments of the invention. When the compensated color point is applied by the backlight control system, the LCD display may have a color point that is closer to an expected/requested color point (i.e. that has a reduced chromaticity error).

When a color point request for a desired color point (X,Y) is received, a temperature of the display 110 is first measured, for example using the temperature sensor 240A, and a difference between the current (measured) temperature (Tcur) and the calibration temperature (Tcal) may be determined as follows:

DeltaT=Tcal−Tcur(° C.) (1)

Next, a compensated color point having chromaticity coordinates (X′,Y′) may be calculated according to the following transformations:

X′=X+mx*DeltaT (2)

Y′=Y+my*DeltaT (3)

where mx and my are the slopes of the temperature dependence curves for the x and y coordinates, as determined at calibration time by measuring the color point of the display over a range of temperatures. For example, mx may be −0.0005° C.⁻¹, while my may be −0.0002° C.⁻¹.

The compensated chromaticity coordinates (X′, Y′) may then be provided to the color management unit 260 and used to set the color point of the LCD display 110.

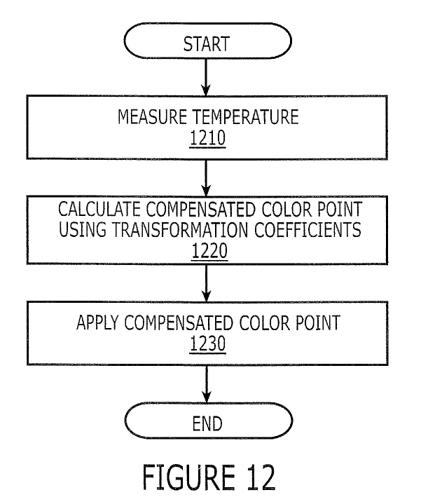

FIG. 11 is a flowchart of operations for generating the transformation coefficients mx and my used to calculate compensated chromaticity coordinates, according to some embodiments of the invention.

Referring to FIG. 11, and LCD display 110 is initially set to a first temperature T1, which may be room temperature (Block 1110). The color point of the LCD display 110 is then measured, for example, using an external calorimeter, such as a PR-650 SpectraScan® Colorimeter from Photo Research Inc. (Block 1120).

The temperature of the LCD display 110 is then increased, (Block 1130), and the color point of the display 110 is measured again at the increased temperature (Block 1140). A check is made in Block 1150 to see if the temperature of the display has been raised up to or over a maximum temperature Tmax. If not, the temperature is then raised again (Block 1130), and the color point of the display is again measured (Block 1140).

If the temperature of the display has reached Tmax, operations proceed to Block 1160.

The process of raising the temperature of the LCD display and measuring the color point of the LCD display may be repeated a number of times so that statistically meaningful information may be obtained. In some embodiments, the display 110 may be raised at least to a temperature of about 70° C., which may approximate an operating temperature of the LCD display 110.

In Block 1160, the color point and temperature information obtained as described above may be analyzed to determine transformation coefficients mx and my. For example, the coefficients mx and my may be obtained from the rate of change of the x-coordinate of the color point of the LCD display 110 versus temperature and the rate of change of the y-coordinate of the color point of the LCD display 110 versus temperature. The transformation coefficients may then be stored by the LCD backlight unit 200. For example, the transformation coefficients may be stored in registers or other memory by the controller 230 and/or the color management unit 260.

FIG. 12 illustrates operations for calibrating an LCD display according to embodiments of the invention. As shown therein, an LCD display 110 may measure a temperature associated with the LCD display 110, such as a temperature within a housing of the LCD display 110, for example, using a temperature sensor 240A. The temperature measurement may be obtained in other ways. For example, the temperature measurement may be obtained from a computer system or other device to which the LCD display 110 is attached.

The transformation coefficients are retrieved from memory, and a compensated color point is then generated using the temperature measurement and the transformation coefficients, as described above (Block 1220). The compensated color point coordinates are then applied to the backlight (Block 1230). That is, the feedback control system of the LCD display 110 sets the color point of the LCD backlight 200 to the compensated color point. However, since the optical properties of the display are temperature-dependent, the actual color point of the LCD display 110 may more closely approximate the requested color point.

In the drawings and specification, there have been disclosed typical embodiments of the invention and, although specific terms are employed, they are used in a generic and descriptive sense only and not for purposes of limitation, the scope of the invention being set forth in the following claims.

That which is claimed is:

1. A method of controlling a display including a backlight unit having a plurality of solid state light emitting devices, the method comprising:
receiving a target color point for the display;
measuring a temperature associated with the display;
generating a compensated target color point in response to the measured temperature; and
setting a color point of the backlight unit to produce the compensated target color point.

2. The method of claim 1, wherein setting the color point of the backlight unit comprises changing a pulse width of a pulse width modulated current drive signal applied to at least one of the plurality of solid state lighting devices.

3. The method of claim 1, wherein the target color point comprises an x-coordinate and a y-coordinate in a two dimensional color space, and wherein generating the compensated target color point comprises transforming the x-coordinate of the target color point using a transformation equation.

4. The method of claim 3, wherein the transformation equation comprises a linear transformation equation including a linear transformation coefficient.

5. The method of claim 3, wherein the transformation equation comprises a first transformation equation, and wherein generating the compensated target color point comprises transforming the y-coordinate of the target color point using a second transformation equation.

6. The method of claim 3, wherein the linear transformation coefficient comprises a first linear transformation coefficient, and wherein the second transformation equation comprises a linear transformation equation including a second linear transformation coefficient.

7. The method of claim 1, wherein generating the compensated target color point comprises generating the compensated target color point in response to a difference between the measured temperature and a calibration temperature.

8. The method of claim 7, wherein generating the compensated target color point comprises generating the compensated target color point using the equations:
X′=X+mx*DeltaT
Y′=Y+my*DeltaT
wherein (X, Y) comprise coordinates of the target color point, (X′, Y′) comprise coordinates of the compensated target color point, mx and my comprise first and second linear transformation coeffiecients, respectively, and DeltaT comprises the difference between the measured temperature and the calibration temperature.

9. The method of claim 1, wherein setting the color point of the backlight unit to the compensated target color point comprises adjusting a pulse width modulation signal that is applied to at least one of the plurality of solid state lighting devices in the backlight unit.

10. A method of calibrating a display including a solid state backlight unit, comprising:
setting a temperature of the display to a first temperature level;
generating light from the solid state backlight unit;
measuring a first color point of light output by the display at the first temperature level;
setting the temperature of the display to a second temperature level that is different from the first temperature level;
generating light from the solid state backlight unit;
measuring a second color point of light output by the display at the second temperature level;
generating a transformation coefficient in response to the first color point, the second color point, and a temperature difference between the first temperature and the second temperature; and
storing the transformation coefficient in the display.

11. The method of claim 10, wherein generating the transformation coefficient comprises performing a linear curve fitting to obtain a linear equation, wherein the transformation coefficient comprises a slope of the linear equation.

12. The method of claim 10, wherein measuring the first color point comprises measuring the first color point using an external calorimeter.

13. A display, comprising:
a solid state backlight unit;
a feedback control system coupled to the solid state backlight unit and configured to receive a target color point for the display, to measure a temperature associated with the display, to generate a compensated target color point in response to the measured temperature, and to set a color point of the backlight unit to produce the compensated target color point.

14. The display of claim 13, wherein the control system comprises a controller, a photosensor coupled to the controller and configured to measure a light output of the backlight unit, and a current driver coupled to the controller and configured to provide a pulse width modulated current drive signal to a solid state lighting element in the backlight unit in response to a command signal from the controller, and wherein the controller is configured to control a pulse width modulation signal applied to at least one solid state light emitting device in the solid state backlight unit.

15. The display of claim 13, wherein the target color point comprises an x-coordinate and a y-coordinate relative to a two dimensional color space, and wherein the control system is configured to transform the x-coordinate of the target color point using a transformation equation to obtain the compensated color point.

16. The display of claim 15, wherein the transformation equation comprises a linear transformation equation including a linear transformation coefficient.

17. The display of claim 16, wherein the transformation equation comprises a first transformation equation and the linear transformation coefficient comprises a first linear transformation coefficient, and wherein the control system is configured to transform the y-coordinate of the target color point using a second transformation equation including a second linear transformation coefficient.

18. The display of claim 13, wherein the control system is configured to generate the compensated target color point in response to a difference between the measured temperature and a calibration temperature.

19. The display of claim 18, wherein the control system is configured to generate the compensated target color point using the equations:
X′=X+mx*DeltaT
Y′=Y+my*DeltaT
wherein (X, Y) comprise coordinates of the target color point, (X′, Y′) comprise coordinates of the compensated target color point, mx and my comprise first and second linear transformation coeffiecients, respectively, and DeltaT comprises the difference between the measured temperature and the calibration temperature.
